(19) United States
(12) Patent Application Publication
(10) Pub. No.: US 2010/0255165 A1
(43) Pub. Date: Oct. 7, 2010

(54) Fitness Nutrition Food Bar and Method of Use

(76) Inventor: Betty Lou Rees, Ankeny, IA (US)

Correspondence Address: DORSEY & WHITNEY LLP;INTELLECTUAL PROPERTY DEPARTMENT, 801 GRAND, SUITE 3900, DES MOINES, IA, 50309, US

(21) Appl. No.: 12/753,487

(22) Filed: Apr. 2, 2010

Related U.S. Application Data
(60) Provisional application No. 61/166,492, filed on Apr. 3, 2009.

(51) Int. Cl. A23L 3/00; F25D 23/02

(52) U.S. Cl. 426/418; 62/449

(57) ABSTRACT

A fitness nutrition food bar device is disclosed. The device includes a food storage assembly having a top side, a bottom side, a first side portion, a second side portion, a rear portion, and a front portion together forming an inner portion. A refrigeration assembly is operably connected to the food storage assembly. An environmental control assembly is operably connected to the food storage assembly. A food repository is positioned within the inner portion of the food storage assembly. A method of optimizing the consumable life of fresh food is also disclosed.

### CROSS-REFERENCE TO RELATED APPLICATIONS

This application claims priority to U. S. Provisional application, Ser. No. 61/166,492 filed Apr. 3, 2009, entitled “Fitness Nutrition Food Bar and Method of Use” the contents of which is incorporated herein by reference in its entirety.

### FIELD OF THE INVENTION

The present invention relates to a food bar or a food storage, display and dispensing device. The present invention more specifically relates to a fitness nutrition food bar for maintaining and dispensing nutritional food for individuals.

### BACKGROUND

Obesity is a condition in which excess body fat has accumulated to an extent that health may be negatively affected. Obesity is the result of a person having a very high amount of body fat in relation to lean body mass, or a Body Mass Index (BMI) of 30 or higher. BMI is a measure of an adult's weight in relation to his or her height, specifically the adult's weight in kilograms divided by the square of his or her height in meters.

Over the past twenty years, obesity among adults in the United States has increased at an alarming rate. In 1990, ten states had a prevalence of obesity less than 10% and no state had a prevalence equal to or greater than 15%. In 1998, obesity rates increased where no state had a prevalence of obesity less than 10%, seven states had a prevalence of obesity between 20-24%, however, no state had prevalence equal to or greater than 25%. By 2007, only one state (Colorado) had a prevalence of obesity less than 20%. Thirty states had a prevalence equal to or greater than 25%, and three of these states (Alabama, Mississippi and Tennessee) had a prevalence of obesity equal to or greater than 30%. As of 2007, approximately sixty million adults, or 30% of the adult population, are now obese, representing a doubling of the rate since 1980.

During the same timeframe, childhood obesity has also increased. As of 2007, 16% of United States children (over nine million) 6-19 years old are overweight or obese, a number that has tripled since 1980. Further, another 15% are considered at risk of becoming overweight. Since 1980, the childhood obesity rate has more than doubled for preschool children aged 2-5 years and adolescents aged 12-19 years, and it has more than tripled for children aged 6-11 years. Overweight adolescents have a 70% chance of becoming overweight or obese adults. This increases to 80% if one or more parent is overweight or obese.

Obesity increases the risk of physical or mental disorders. These disorders include diabetes mellitus type 2 (type 2 diabetes), high blood pressure, high blood cholesterol, and high triglyceride levels. Obesity also causes negative health consequences from increased fat mass (osteoarthritis, obstructive sleep apnea, social stigmatization) or by the increased number of fat cells (diabetes, cancer, cardiovascular disease, and non-alcoholic fatty liver disease). Further, obesity has a significant impact on life expectancy. On average, obesity reduces life expectancy by six to seven years.

Obesity is generally caused by a combination of excessive caloric intake and lack of physical activity. A limited number of obesity cases are due to genetics, medical reasons, or psychiatric illness.

Excessive caloric intake can be directly attributed to the life style of United States citizens. Unhealthy, refined foods are fast and easy to access. In the United States consumption of fast food meal has tripled and calorie intake from fast food has quadrupled between 1977 and 1995. Further, demands of work and family limit the amount of time available to prepare healthy foods or a healthy meal.

Unavailable today is a device providing readily accessible, healthy food alternatives. What is needed is a device which provides easy access to a consumer while encouraging consumption of healthy foods. The device will provide readily accessible healthy food alternatives which are the first option for snacks and meals based upon visual placement, convenience, and ease of access.

Accordingly, it would be desirable to provide a device allowing easy and convenient access to healthy food alternatives, reduces spoilage of healthy foods, and encourages a low caloric intake lifestyle.

### SUMMARY

A fitness nutrition food bar device is disclosed. The device includes a food storage assembly having a top side, a bottom side, a first side portion, a second side portion, a rear portion, and a front portion together forming an inner portion. A refrigeration assembly is operably connected to the food storage assembly. An environmental control assembly is operably connected to the food storage assembly. A food repository is positioned within the inner portion of the food storage assembly.

A method of optimizing the consumable life of fresh food is also disclosed. The method includes placing fresh food into a fitness nutrition food bar device, actuating an environmental control assembly to optimize conditions within an inner portion of the fitness nutrition food bar device, and closing the access door to the fitness nutrition food bar device.

### BRIEF DESCRIPTION OF THE DRAWINGS

The invention may be best understood by reference to the following description taken in conjunction with the accompanying drawing figures in which:

FIG. 1 is an isometric view of a side-opening fitness nutrition food bar device according to one or more examples of embodiments, illustrating pivotal movement of the access portion or door in dashed line.

FIG. 2 is a side view of the fitness nutrition food bar of FIG. 1, illustrating an internal arrangement and mounting within a cabinet structure according to one or more examples of embodiments.

FIG. 3 is an isometric view of an internal drawer assembly of the fitness nutrition food bar of FIG. 1.

FIG. 4 is an isometric view of a top-opening fitness nutrition food bar device according to one or more examples of embodiments, illustrating pivotal movement of the access portion or door in dashed line.

FIG. 5 is a top down view of the internal arrangement of food storage receptacles of the fitness nutrition food bar of FIG. 4.

FIG. 6 is a close-up isometric view of food storage receptacles of the fitness nutrition food bar of FIG. 4.

### DETAILED DESCRIPTION

The invention is generally directed to a fitness nutrition food bar device or assembly for conveniently storing and providing easy access to healthy and nutritious fresh foods. The Figures illustrate one or more exemplary embodiments of the present invention.

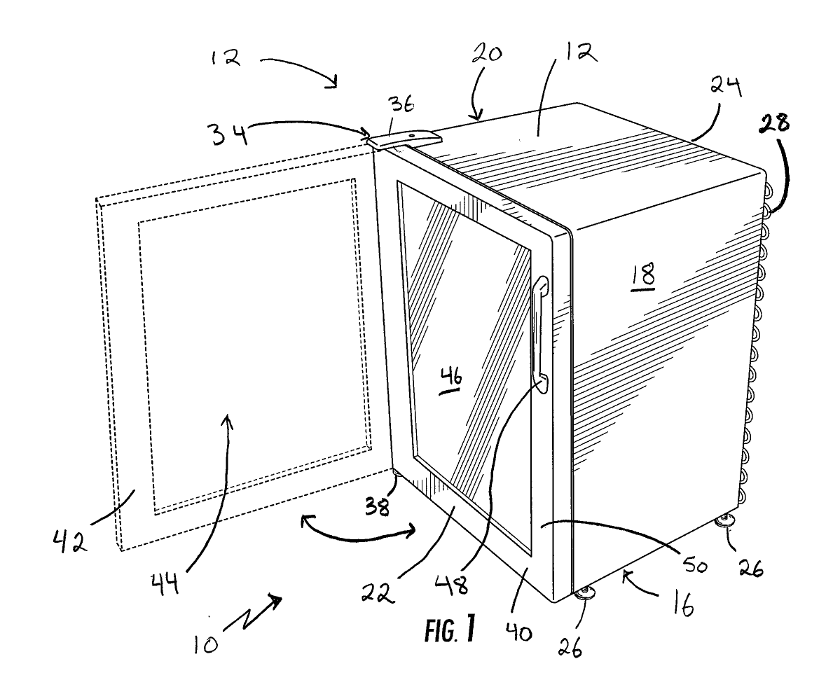

Referring to the Figures, a fitness nutrition food bar device 10 is provided. The fitness nutrition food bar device 10 includes a food storage assembly 12. As illustrated in FIG. 1, the food storage assembly 12 may include a top side 14 and a bottom side 16. The top and bottom sides 14, 16 are generally aligned in a first plane, parallel to one another and parallel to the ground or support surface. The top and bottom sides 14, 16 may be separated by a first side portion 18 and a second side portion 20. The first and second side portions 18, 20 are generally aligned in a second plane, perpendicular to the first plane. The top and bottom sides 14, 16 may further be separated by a front portion 22 and rear portion 24. The front and rear portions 22, 24 may be aligned in the second plane, perpendicular to the first plane. Further, the front and rear portion 22, 24 may be generally arranged perpendicular to the first and second side portions 18, 20. The top side 14, bottom side 16, first side portion 18, second side portion 20, front portion 22 and rear portion 24 may be attached to one another by weld. In one or more examples of embodiments, the top side, bottom side, first side portion, second side portion, front portion and/or rear portion may be continuously formed by a single piece or material and arranged by bending, crimping or other physical process to form the food storage assembly. Further, in one or more examples of embodiments, the top side, bottom side, first side portion, second side portion, front portion and rear portion may be attached to one another by bolt, bracket, adhesive, or any other known or later developed process or material with sufficient strength to form the food storage assembly. The top side, bottom side, first side portion, second side portion, front portion and rear portion may be formed of metal, plastic, or any other known or later developed material with sufficient strength and rigidity to form the food storage assembly. The food storage assembly 12 shown in FIG. 1 is generally rectangular in shape. However, in one or more examples of embodiments, the food storage assembly may be square, triangular, or any other polygonal shape or arrangement appropriate to form the food storage assembly.

The food storage assembly 12 may include at least one support assembly 26. As illustrated in FIG. 1, a plurality of support assemblies 26, and specifically four support assemblies, are connected to the bottom side 16 of the food storage assembly 12. The support assemblies 26 contact the ground or surface to support the food storage assembly 12. The support assemblies 26 may be independently adjustable. As shown in FIG. 1, the support assemblies 26 have a foot portion and a threaded portion. The bottom side 16 of the food storage assembly 12 removably receives the threaded portion of the support assemblies 26, enabling height adjustment of the food storage assembly 12. In one or more examples of embodiments, the support assemblies may be permanently attached to the food storage assembly by bolt, adhesive, weld, or other method of attachment. Further, in one or more examples of embodiments, the support assemblies may be rollers, casters, or other structure allowing for movement of the food storage assembly. In one or more examples of embodiments, the food storage assembly may not include support assemblies.

The food storage assembly 12 may include a refrigeration assembly 28. As shown in FIG. 1, the food storage assembly 12 may include condenser coils connected to the rear portion. The refrigeration assembly 28 may include additional known structural features for a cyclic refrigeration, a thermo-electric cooling system, or a vapor-compression refrigeration cycle. These may include, but are not limited to, a compressor or pump, expansion valve, evaporator, gas or liquid coolant, and any structural components for removing heat from an enclosed space, specifically the food storage assembly 12.

The food storage assembly 12 may include an environmental control assembly 30. The environmental control assembly 30 may include a humidifier assembly and/or a dehumidifier assembly 32. The humidifier and/or dehumidifier assemblies 32 may be used to maintain optimum humidity conditions within the food storage assembly 12 for storage of fresh foods. The food storage assembly may be held at an adjustable, constant humidity, or the food storage assembly may have adjustable zones for maintaining multiple humidity conditions.

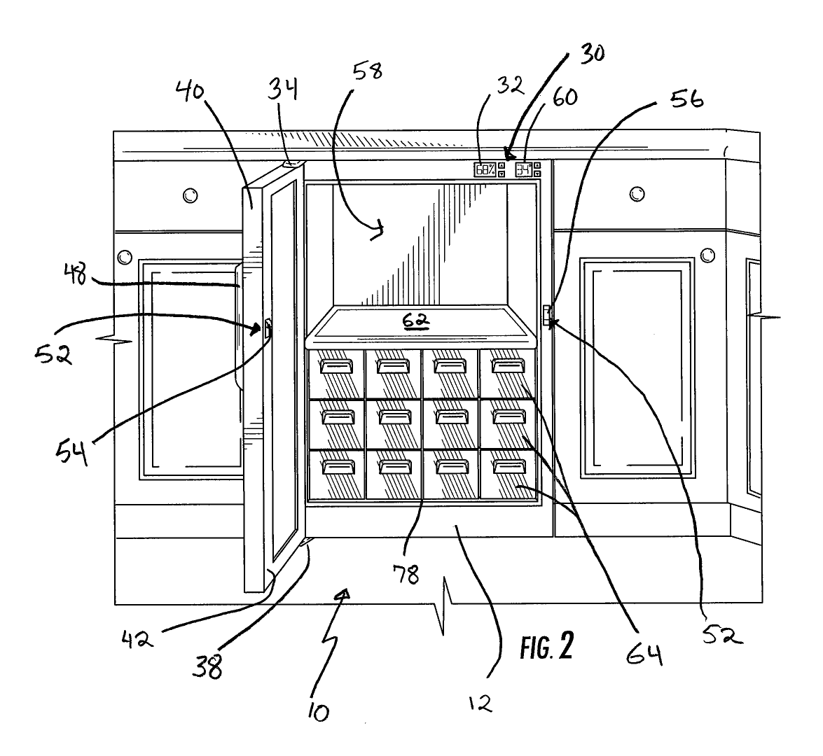

The food storage assembly 12 may include a hinge assembly 34. As illustrated in FIG. 1, the hinge assembly 34 connects an access portion or door 40 to the food storage assembly 12. The hinge assembly 34 may include a top or first portion and a bottom or second portion. As illustrated, the top or first portion 36 is connected to the top side 14 of the food storage assembly 12. As shown in FIG. 2, the bottom or second portion 38 is connected to the bottom side 16 of the food storage assembly 12. The top and bottom portions 36, 38 of the hinge assembly 34 may be attached to the food storage assembly 12 by bolt, adhesive, weld or other method or structure sufficient to support an access portion or door 40. In one or more examples of embodiments, the hinge assembly 34 may be positioned on the first side portion 18 or second side portion 20. Further, in one or more examples of embodiments, the hinge assembly 34 may include a single portion, for example, but not limited to, a continuous hinge.

As shown in FIGS. 1 and 2, the food storage assembly 12 may include an access portion or door 40. The access portion or door 40 may include an inner portion or side 42 and an outer portion or side 44. As illustrated, the access portion or door 40 is positioned as the front portion 22 of the food storage assembly 12. The access portion or door 40 is rotatably received by the hinge assembly 34, connecting the access portion or door 40 to the food storage assembly 12 and enabling pivotal movement of the access portion or door 40 in relation to the food storage assembly 12, as illustrated in dashed line in FIG. 1. When the access portion or door 40 is closed, the inner portion or side 42 is in contact with the food storage assembly 12.

The access portion or door 40 may include an aperture 44. As shown in FIG. 1, the aperture 44 passes entirely through a portion of the access portion or door 40. Positioned within the aperture 44 and carried by the access portion or door 40 is a transparent portion or window 46. The window 46 may be formed of glass, plastic, or any other transparent material with sufficient heat transfer or thermal insulation properties to maintain a target temperature within the food storage assembly 12.

The access portion or door 40 may include a handle 48. As illustrated in FIGS. 1 and 2, the handle 48 is connected to the outer portion or side 50 of the access portion or door 40 to assist in the pivotal movement of the access portion or door 40. The handle 48 may be attached to the access portion or door 40 by bolt, weld, adhesive, or other method of attachment. In one or more examples of embodiments, the handle 48 may be incorporated into the access portion or door 40. Further, in one or more examples of embodiments, the access portion or door may not include a handle.

The access portion or door 40 may also include a latching assembly 52. As shown in FIG. 2, the latching assembly 52 may include a male portion 54 and a female portion 56. The male portion 54 may be carried by the inner portion or side 42 of the access portion or door 40 and the female portion 56 may be carried by the food storage assembly 12. As illustrated, the male portion 54 includes a hook and the female portion 56 includes a portion for receiving the hook. In one or more embodiments, the latching assembly 52 may be magnetic, mortise, or other latching structure for temporarily maintaining the access portion or door 40 in a closed position.

The food storage assembly 12 may include an inner portion or interior 58. As illustrated in FIG. 2, the inner portion 58 is located behind the access portion or door 40 and formed by and within the top side, bottom side, first side portion, second side portion and rear portion. The food storage assembly 12 may maintain a target temperature and/or humidity within the inner portion of the food storage assembly 12.

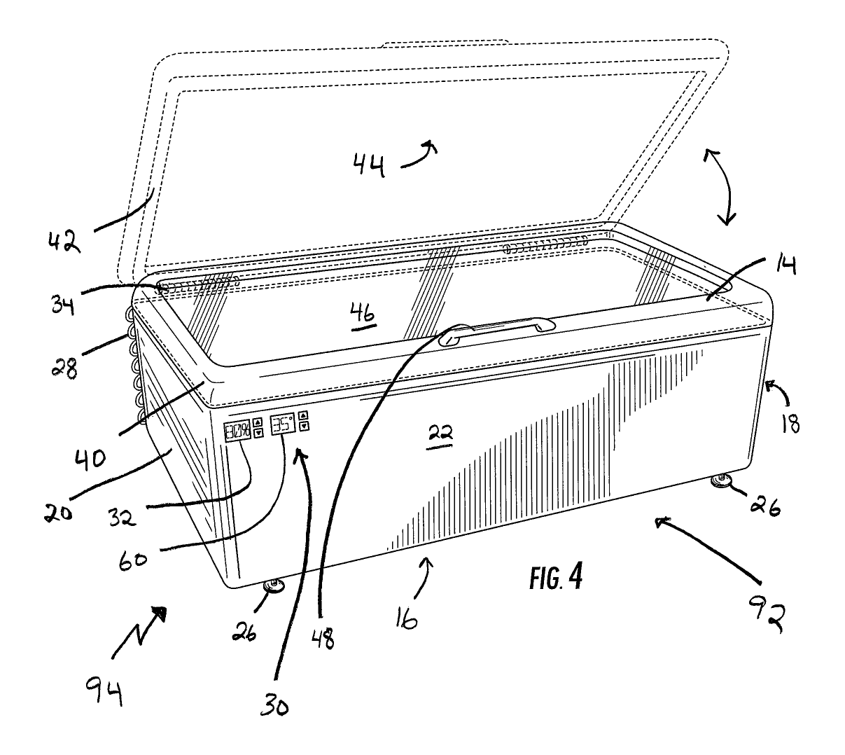

As shown in FIG. 2, the inner portion or interior 58 of the food storage assembly 12 may include a temperature control assembly 60 and/or humidity control assembly 32. The temperature control assembly 60 may include a digital display and adjustment keys for display and adjustment of a target temperature. The temperature control assembly 60 may be in communication with the refrigeration assembly 28 to enable control and maintain the target temperature within the inner portion of the food storage assembly 12. The humidity control assembly 32 may include a digital display and adjustment keys for display and adjustment of a target humidity. The humidity control assembly 32 may be in communication with the humidifier and/or dehumidifier to enable control and maintain the target humidity within the inner portion 58 of the food storage assembly 12. In one or more examples of embodiments, the temperature control assembly 60 and/or humidity control assembly 32 may have control elements to control and maintain multiple zones of temperature and humidity within the inner portion of the food storage assembly 12. In one or more examples of embodiments, the temperature control assembly 60 and/or humidity control assembly 32 may include a manual adjustment assembly, for example, but not limited to, a manually slidable lever or rotatable dial which may adjust a damper or similar structure, for adjustment of a target temperature and/or humidity. Further, in one or more examples of embodiments, and as shown in FIG. 4, the temperature control assembly 60 and/or humidity control assembly 32 digital display and adjustment keys may be positioned on the outside of the food storage assembly 12.

The inner portion of the food storage assembly 12 may include a flat assembly or tray 62. As shown in FIG. 2, the flat assembly or tray 62 may be adjustable to different heights and/or removable. In one or more examples of embodiments, the flat assembly or tray 62 may be permanently connected to the inner portion of the food storage assembly 12. In one or more examples of embodiments, the inner portion 58 may include a plurality of flat assemblies or trays 62. Further, in one or more examples of embodiments, the inner portion 58 may not include any flat assemblies or trays. The flat assembly or tray 62 may be opaque or transparent and may be formed of glass, plastic, metal, or any other material sufficient to support and/or display fresh foods.

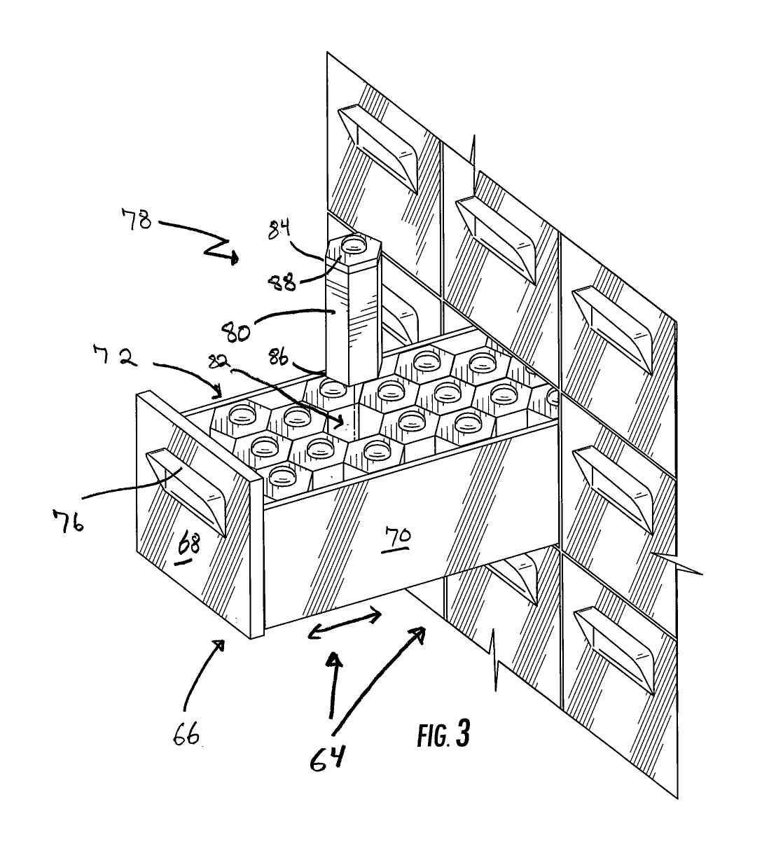

The inner portion 58 of the food storage assembly 12 may include a food repository 64. As shown in FIG. 2, the food repository 64 may include a storage compartment or drawer 66. The storage compartment or drawer 66 may be removably received within the inner portion 58 of the food storage assembly 12. As can be seen in FIG. 3, the storage compartment or drawer 66 may include a front portion 68, a first side portion 70, a second side portion 72, a rear portion (not shown), and a bottom or support portion (not shown). The front portion 68 and rear portion (not shown) are generally aligned parallel to one another. Separating the front and rear portion are the first side 70 and second side 72 portions, which are generally aligned parallel to one another and perpendicular to the front and rear portion. Separating the front and rear portions and first and second sides is the bottom or support portion, which may be arranged perpendicular to the front and rear portion and at a right angle or ninety degrees to the first and second sides. The front and rear portions, first and second side portions and bottom or support portion may form a hollow pocket or reservoir for receiving fresh foods. The storage compartment or drawer 66 may include a handle portion 76 positioned on the front portion 68. The handle portion 76 may be attached, connected or integrally formed into the front portion of the storage compartment or drawer 66. The storage compartment or drawer 66 may be formed of plastic, metal, or any other material with sufficient strength to store fresh foods.

As illustrated in FIGS. 2 and 3, the inner portion 58 of the food storage assembly 12 may include one or more storage compartments or drawers 66. The inner portion 58 may include a compartment assembly 78 for removably receiving a plurality of storage compartments or drawers 66. The compartment assembly 78 may be permanently or removably received within the inner portion 58 and separate each storage compartment or drawer 66 from one another. The compartment assembly 78 may also include a sliding structure enabling each storage compartment or drawer 66 to slide outward from the inner portion of the food storage assembly 12, as shown in FIG. 3. The compartment assembly 78 may be formed of similar materials as the storage compartment or drawer 66 or the food storage assembly 12.

The food storage assembly 12 may include a food storage or deposit receptacle 80. As shown in FIG. 3, the food storage or deposit receptacle 80 may be removably received into the hollow pocket or reservoir 82 of the storage compartment or drawer 66. The food storage or deposit receptacle 80 may be formed of similar materials as the storage compartment or drawer 66 or the food storage assembly 12. While the illustrated food storage or deposit receptacle 80 is hexagonal in shape, it is contemplated that the food storage or deposit receptacle 80 may be formed of any shape without departing from the overall scope of the present invention. To this end, the food storage or deposit receptacle 80 may be cylindrical, conical, or any other polygonal or shape.

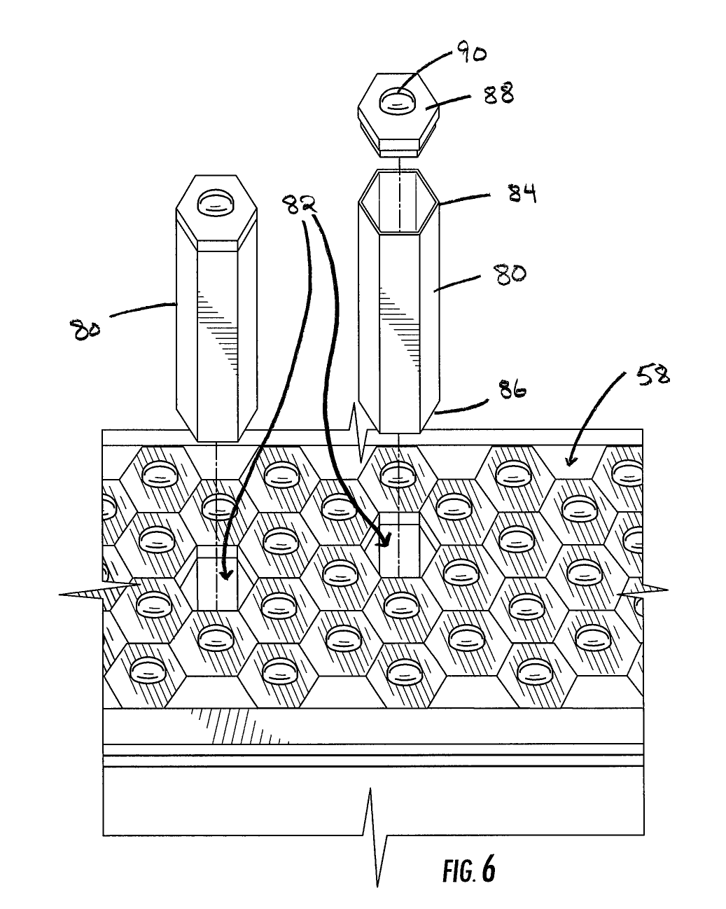

The food storage receptacle 80 may include a first end 84 and a second end 86. As shown in FIG. 3, the first end 84 may include a top or lid 88 for sealing the food storage receptacle 80. The top or lid 88 may have an inner diameter equal to or slightly larger than the outer diameter of the food storage receptacle 80, allowing the top or lid to fit around the outer diameter of the food storage receptacle. In one or more examples of embodiments, and as shown in FIG. 6, the top or lid 88 may have an inner diameter slightly smaller than the outer diameter of the food storage receptacle 80, allowing the top or lid to fit within the outer diameter of the food storage receptacle. Further, in one or more examples of embodiments, the food storage receptacle 80 may not include a top or lid. The top or lid 88 may have a handle 90 to assist in removing the top or lid from the food storage receptacle 80.

FIGS. 4-6 illustrate an alternative embodiment of a fitness nutrition food bar device 92 in accordance with one or more examples of embodiments of the present invention. The alternative embodiment of the fitness nutrition food bar device 92 is substantially similar to the fitness nutrition food bar device 10 described above, but for the structural differences explained below, and like reference numerals will be used to illustrate like components.

As illustrated in FIG. 4, the alternative embodiment of a fitness nutrition food bar device 92 includes an access portion or door 40 positioned on the top side 14 of the food storage assembly 94. The access portion or door 40 is connected to the food storage assembly 94 by a hinge assembly 34, illustrated as two mortise hinges attached to the access portion or door 40 and the rear portion 24 of the food storage assembly 94. The access portion or door 40 pivots upward, enabling an individual to access the contents of the inner portion 58 from the top down.

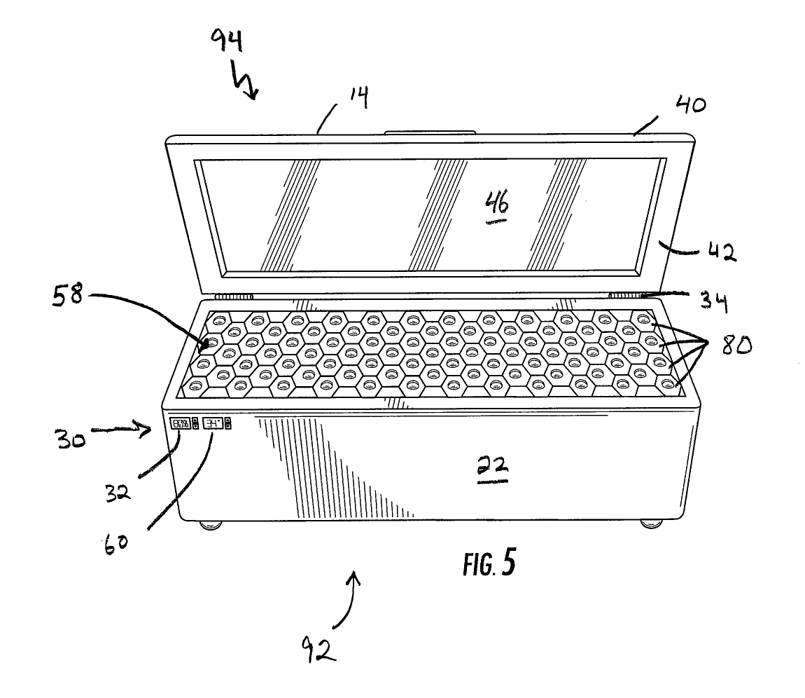

The inner portion 58 of the food storage assembly 94 may include a food repository 64. The food repository 64 may include only food storage receptacles 80. As shown in FIGS. 5 and 6, the alternative embodiment of a fitness nutrition food bar device 92 does not include a flat assembly or tray or storage compartments or drawers. The inner portion 58 includes one or more food storage receptacles 80. As illustrated, the inner portion includes a plurality of food storage receptacles 80. As best shown in FIG. 6, the food storage receptacles 80 may be removable from the inner portion 58, and may include a removable top or lid 88.

In operation, the fitness nutrition food bar device 10 or 92 may be free-standing, positioned on the ground or floor, on a counter top, or within a cabinet arrangement similar to a dishwasher or stove, as for example, shown in FIG. 2. Accordingly, the fitness nutrition food bar device 10 or 92 may be assembled to different sizes. In one or more examples of embodiments, the fitness nutrition food bar device 10 or 92 may be compact in size. For example, the fitness nutrition food bar device 10 or 92 may have the ability to be positioned on a counter top, and may be smaller in size than twenty-four (24) inches tall, twenty-four (24) inches wide, and twenty-four (24) inches deep, however said size is not intended to be limiting in any way.

The fitness nutrition food bar device 10 or 92 may optimize the conditions for maintaining fresh food for the longest period possible by adjustably controlling both temperature and humidity within the inner portion. The temperature control assembly 60 and/or humidity control assembly 32 may maintain a single temperature and/or humidity within the inner portion 58 of the food storage assembly 12. In one or more examples of embodiments, the temperature control assembly 60 and/or humidity control assembly 32 may maintain a multiple, different temperatures and/or humidities in different zones of the inner portion. The zones may include each of the storage compartments or drawers 66. Each drawer 66 may include a temperature and/or humidity sensor (not shown) and individual refrigeration assemblies and/or humidifier and/or dehumidifier assemblies (not shown) to control and adjust temperature and/or humidity. In one or more examples of embodiments, where the inner portion 58 includes food storage receptacles 80 instead of storage compartments or drawers, each food storage receptacle 80 may represent a different zone and include a temperature and/or humidity sensor (not shown) and individual refrigeration assemblies and/or humidifier and/or dehumidifier assemblies (not shown) to control and adjust temperature and/or humidity. A user may adjust or set the temperature and/or humidity by adjusting the temperature control assembly and/or humidity control assembly for one or more zones to ensure optimal freshness and limit degradation and spoilage of fresh foods.

In use, a user may prepare fresh foods for human consumption. This may entail washing the food, removing any skins, removing any stems or other inedible parts of the food, or other preparation necessary for each type of fresh food prior to human consumption. In one or more example of embodiments, the fresh food may be purchased prepackaged for fast loading into the fitness nutrition food bar device 10. The prepackaged fresh food may be prepared and ready for human consumption upon removal of the packaging. The prepackaged fresh food may include different prepackaged quantities, for example, but not limited to, a quantity to fill a single food storage receptacle, two or more food storage receptacles, one or more storage compartments or drawers 66, or one or more flat assemblies or trays 62. The prepackaged food may also be provided in a package corresponding in shape to or forming the shape of one or more receptacles 80. The prepackaged fresh food may be obtained according to any suitable means, such as for example purchased or acquired from a licensed supplier, and further acquired at a commercial location, for example, but not limited to, a grocery store or food cooperative. The prepackaged fresh food may be acquired or purchased through mail order, telephonic order processing, or through an internet portal or website.

The user may open the access portion or door 40 to access the inner portion 58 of the food storage assembly 12 or 94. Depending on the applicable arrangement, the user may place fresh food in one or more food storage receptacles 80, or place a prepackaged receptacle in the interior 58 or in one or more storage compartments or drawers 66, or upon one or more flat assemblies or trays 62. Once placed into the food storage assembly 12, the user may close the access portion or door 40. The food is then accessible by any person for fast, easy, and nutritious snacks or meals.

There are several advantages to the fitness nutrition food bar. The user will have fast and easy access to nutritious, natural foods which may have the added advantages of being low calorie, high fiber and contain natural vitamins and minerals. Likewise, the fitness nutrition food bar directly battles obesity and the respective adverse health effects by eliminating the excuse of convenience for reliance on unhealthy snacks and fast food, instead providing a readily available nutritious alternative and reducing the caloric intake of individuals. Third, the fitness nutrition food bar maximizes the edible life of fresh foods by decreasing the rate of spoilage. Fourth, the fitness nutrition food bar is versatile, and may be employed at home, work, or other place of employment, eliminating the excuse of not having readily available, healthy food alternatives.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references, including but not limited to, upper, lower, upward, downward, left, right, leftward, rightward, top, bottom, above, below, vertical, horizontal, clockwise, counterclockwise, x-axis, y-axis, and z-axis, central, are only used for identification purposes to aid the reader's understanding of the embodiments of the present invention, and do not create limitations, particularly as to the position, orientation, or use of the invention unless specifically set forth in the claims. Joinder references (e.g., attached, coupled, connected) are to be construed broadly and may include intermediate members between a connection of elements and relative movement between elements. As such, joinder references do not necessarily infer that two elements are directly connected and in fixed relation to each other.

In some instances, components are descried with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to preferred embodiments, persons skilled in the art will recognize that changes may be made in form and detail without departing from the spirit and scope of the invention

What is claimed is:

1. A fitness nutrition food bar device comprising:
a food storage assembly having a top side, a bottom side, a first side portion, a second side portion, a rear portion, and a front portion together forming an inner portion;
a refrigeration assembly operably connected to the food storage assembly;
an environmental control assembly operably connected to the food storage assembly; and
a food repository positioned within the inner portion of the food storage assembly.

2. The fitness nutrition food bar device of claim 1 wherein the front portion includes an access door pivotally connected to the food storage assembly for access to the inner portion.

3. The fitness nutrition food bar device of claim 1 wherein the top side includes an access door pivotally connected to the food storage assembly for access to the inner portion.

4. The fitness nutrition food bar device of claim 1 wherein the environmental control assembly includes at least one of a temperature control assembly and a humidity control assembly.

5. The fitness nutrition food bar device of claim 1 wherein the food repository includes a storage drawer.

6. The fitness nutrition food bar device of claim 5 wherein the food repository further includes a storage receptacle removably received by the storage drawer.

7. The fitness nutrition food bar device of claim 1 wherein the food repository includes a storage receptacle.

8. The fitness nutrition food bar device of claim 7 wherein the storage receptacle includes a removable lid.

9. A method of optimizing the consumable life fresh food comprising:
placing fresh food into a fitness nutrition food bar device;
actuating an environmental control assembly to optimize conditions within an inner portion of the fitness nutrition food bar device; and
closing the access door to the fitness nutrition food bar device.

10. The method of optimizing the consumable life fresh food of claim 9, wherein actuating an environmental control assembly further comprises adjusting at least one of a temperature control assembly and a humidity control assembly.

11. The method of optimizing the consumable life fresh food of claim 10, wherein adjusting at least one of the temperature control assembly and humidity control assembly further comprises adjusting at least one of the temperature and the humidity within at least one zone.

12. The method of optimizing the consumable life fresh food of claim 11, wherein at least one zone includes at least one of a storage drawer and a storage receptacle.
